(19) United States
(12) Patent Application Publication
(10) Pub. No.: US 2009/0096418 A1
(43) Pub. Date: Apr. 16, 2009

(54) ELECTRICAL ENERGY STORAGE DEVICE, IN PARTICULAR FOR EQUIPPING A MOTOR VEHICLE

(76) Inventors: Roger ABADIA, Neuilly Plaisance (FR); Fabien Guerin, Chatillon (FR); Alexis Hosni, Paris (FR)

Correspondence Address: BERENATO, WHITE & STAVISH, LLC, 6550 ROCK SPRING DRIVE, SUITE 240, BETHESDA, MD, 20817, US

(21) Appl. No.: 12/245,924

(22) Filed: Oct. 6, 2008

(30) Foreign Application Priority Data
Oct. 12, 2007 (FR) 0758281
Oct. 12, 2007 (FR) 0758283

(51) Int. Cl. H02J 7/00

(52) U.S. Cl. 320/116

(57) ABSTRACT

An electrical energy storage device (1), in particular for equipping a motor vehicle, comprises:

at least one energy storage cell (2), p1 an electronic unit (3), comprising in particular an electronic card (11), the electronic unit being in particular different from a voltage converter,

at least one electrical connection (4) connecting the at least one energy storage cell and the electronic unit to enable this electronic unit to have available information representing an electrical quantity, in particular an electrical potential, of the energy storage cell, the electrical connection comprising at least one substantially rigid electrical element (12) provided with an end (15) remote from the cell (2).

This application is a US Utility Patent Application, based on French Patent Application Numbers 0758281 and 0758283 filed Oct. 12, 2007 and are hereby incorporated by reference in their entireties.

### BACKGROUND OF THE INVENTION

1. Field of the Invention

The invention concerns an electrical energy storage device, in particular for equipping a motor vehicle.

2. Description of Related Art

As is known, such an energy storage device is for example arranged so as to be charged during a recuperative braking phase and discharged during phases of starting and acceleration of the vehicle.

In a chain of energy storage cells connected in series, these cells each for example comprising a supercapacitor, differences in charging voltage may appear between the cells because in particular of:
differences between the capacitances inherent in the manufacture of the cells,
the existence of leakage currents of different intensities.

The persistence of these differences over time may cause accelerated aging, or even destruction, of the cells withstanding the highest charging voltages.

It is known how to provide to provide a balancing circuit for correcting these imbalances.

Reference can be made for example to the patent application US 200310214267.

Such a balancing circuit is connected to the various energy storage cells by wires so as to take the potential of the cells to this balancing circuit.

The use of wires has a certain number of drawbacks.

For example, it is necessary to manage excess wire lengths, the said wires presenting the risk of attaching to elements in the vicinity during assembly or even being cut.

In addition the diameter of the wires is relatively small, which makes it difficult to perform the operations of welding the wires to a power conductor or an electronic card.

Finally, the wires conventionally comprise copper to be connected to an aluminium power conductor. These materials generally require connection by welding in order to prevent corrosion of the connection at 0 milliamperes.

### SUMMARY OF THE INVENTION

The invention aims in particular to remedy the aforementioned drawbacks.

Thus an object of the invention is an electrical energy storage device, in particular for equipping a motor vehicle, comprising:
at least one energy storage cell,
an electronic unit comprising in particular an electronic card, the electronic unit being in particular different from a voltage converter,
at least one electrical connection connecting the said at least one energy storage cell and the electronic unit to enable this electronic unit to have available information representing an electrical quantity, in particular an electrical potential, of the energy storage cell.

The electrical connection advantageously comprises at least one substantially rigid electrical connection provided with an end remote from said cell.

This distancing between the said end and the cell corresponds for example to a distance of 1 mm or 2 mm, or even more.

“Substantially rigid” means in particular the property that an element that keeps substantially its shape under the effect of its own weight has, unlike for example a flexible wire that deforms under the effect of it own weight.

By virtue of the invention, it is possible for example, when the energy storage cell is placed vertically, to simply send back a potential taken on this energy storage cell, the said distant end of the connection element then serving to recover the potential on the top of the cell.

In particular, assembling a substantially rigid electrical connection element is simpler than that of a flexible wire.

If so desired, the electronic unit can be housed in a housing distinct from a housing in which the energy storage cells are placed.

In an example of implementation of the invention, the energy storage cell extend substantially along a longitudinal axis, and the substantially rigid electrical connection element comprises at least one portion extending substantially parallel to the longitudinal axis of the cell.

For example, the substantially rigid electrical connection element comprises at least one arm, in particular extending vertically. This arm comprises for example two parallel rectilinear edges.

Where applicable, the substantially rigid electrical element is connected to a power conductor, in particular a power connection bar itself connected to the energy storage cell.

The substantially rigid electrical connection element can be welded to the power connection bar.

In a variant, the substantially rigid electrical connection element can be assembled mechanically with the power connection bar, in particular by screwing or riveting or crimping.

In an example of implementation of the invention, the substantially rigid electrical connection element is fixed, in particular by welding or mechanical assembly, to a wall of the energy storage cell, in particular a lateral wall thereof.

If so desired, the substantially rigid electrical connection element can be formed directly on a power connection bar connected to the energy storage cell.

For example, the substantially rigid electrical connection element issues from a cropping of material on the power connection bar.

In an example of implementation of the invention, one of the ends of the substantially rigid electrical connection element is fixed to the electronic unit.

The substantially rigid electrical connection element can extend for example between two adjoining energy storage cells.

Where applicable, the substantially rigid electrical connection element has a substantially polygonal transverse section, in particular rectangular. In a variant, this section may for example be circular or oval.

In an example of implementation of the invention, the substantially rigid electrical connection element is bare, having no insulating covering, in particular an insulating sheath.

The substantially rigid electrical connection element can be produced at least partially from copper or aluminium.

The energy storage cell preferably comprises at least one supercapicitor. In a variant, the energy storage cell can comprise for example an Li-On (lithium-ion), Ni-Mi (nickel-metal hydride) or lead battery.

Preferably, the electronic unit comprises a circuit for balancing the energy storage cells. In a variant, other types of electronic card can be provided.

Another object of the invention, in combination with or independently of the above, is an energy storage device, in particular for equipping a motor vehicle, comprising:
at least two energy storage cells,
an electronic unit, comprising in particular an electronic card, the electronic unit being in particular different from a voltage converter,
at least two electrical connections connecting respectively the energy storage cells to the electronic unit to enable this electronic unit to have available information representing an electrical quantity, in particular an electrical potential, of the energy storage cells, the electrical connections being carried at least partially by a common insulating support.

The invention thus makes it possible to assemble the various elements of the device in a simple manner. For example, it is possible, where applicable, to have, on a single common insulating support, all the electrical connections useful for taking the potentials of the cells back to the electronic unit.

Preferably, the insulating support comprises a plate.

Advantageously, the insulating support is produced from plastics material.

In an example of implementation of the invention, at least one of the electrical connections comprises at least one conductive portion embedded in the material of the insulating support.

The insulating support can in particular be produced by insert moulding of the conductive portion of the electrical connection.

In a variant, at least one of the electrical connections can comprise at least one conductive portion extending over an external face of the insulating support.

In an example of implementation of the invention, at least one of the electrical connections can comprise an electrical connection element carried by the insulating support and comprising a connection lug projecting from the insulating support.

The connection lug is for example welded or, in a variant, assembled mechanically, for example by screwing or riveting, with another electrical connection element of the electrical connection.

This connection lug can, where applicable, extend substantially perpendicular to the insulating support. In a variant, this lug can extend parallel to the insulating support.

In an example of implementation of the invention, the insulating support can comprise at least one opening for allowing another electrical connection element of the electrical connection to pass.

If so desired, the electronic unit comprises an electronic card provided with at least one opening for allowing an electrical connection element to pass.

The insulating support can comprise, where applicable, at lest one element for holding the energy storage cells with respect to one another, this element comprising in particular at least one holding skirt.

In an example of implementation of the invention, the electronic unit, in particular the electronic card, is disposed on the insulating support.

### BRIEF DESCRIPTION OF THE DRAWINGS

The invention can be better understood from a reading of the following detailed description of non-limitative example embodiments of the invention, and an examination of the accompanying drawing, on which:
FIG. 1 depicts, schematically and partially, in plan view, an energy storage device according to an example of implementation of the invention,
FIG. 2 depicts, schematically and partially, in section along II-II, the device of FIG. 1,
FIG. 3 illustrates, schematically and partially, in section, the junction between an electrical connection element and a printed circuit card of an electronic unit of the device of FIG. 1,
FIG. 4 depicts, schematically and partially, in perspective, the connection element and the printed circuit card of FIG. 3,
FIG. 5 is a view in section, schematic and partial, of the junction between two electrical connection elements of the device of FIG. 1,
FIG. 6 is a view in section, schematic and partial, of the junction between an electrical connection element and a power connection bar of the device of FIG. 1,
FIG. 7 depicts, schematically and partially, in perspective, a connection element according to an example of implementation of the invention,
FIGS. 8 and 9 depict, schematically and partially, in perspective, a connection element according respectively to two other examples of implementation of the invention, and
FIG. 10 is a view in section along X-X, schematic and partial, of the connection element of FIG. 9.

### DETAILED DESCRIPTION OF PREFERRED EMBODIMENTS

FIG. 1 depicts an energy storage device 1 of a micro-hybrid device with an alternator starter for a motor vehicle.

Where applicable, the micro-hybrid device comprises a recuperative braking system.

The device 1 comprises a plurality of energy storage cells 2, ten in number in the example described, disposed vertically along a longitudinal axis X, and an electronic unit 3.

Each cell 2 comprises a supercapacitor or EDLC in English (electrochemical double layer capacitor).

In a variant, the cells 2 can comprise an Li-On (lithium-ion), NI-MH (nickel-metal hydride) or lead battery.

The electronic unit 3 comprises a printed circuit card 11 forming a circuit for balancing the cells 2.

This electronic unit 3 is distinct from the DC/DC or AC/DC converters, not shown, which are connected to the cells 2 via power conductors, in particular power bars.

The cells 2 and electronic unit 3 are disposed in a housing 10, for example made from plastics material, as illustrated in FIG. 2.

The cells 2 are connected together in series by means of power conductors formed, in the example described, by power bars 5 or bus bars in English.

The cells 2 are connected in pairs by means of power bars 5 alternately placed on the top and bottom of the cells 2, as can be seen in FIG. 2 in particular.

Electrical connections 4 are provided for connecting the energy storage cells 2 and the electronic unit 3 to enable the balancing circuit to have available information representing an electrical quantity, in particular an electrical potential of the energy storage cells 2.

These electrical connections 4 (with a current with an intensity of approximately 10 mA for example passing through them) are different from power connections (with for example a current with an intensity of approximately 200 A, or even with an intensity peak of 1000 A, passing through them).

In the example described, the potential taken on the bottom of the cells 2 is taken back by means of vertical electrical connection elements 12.

The rigid connection elements 12 are produced from copper or aluminium for example, and have a substantially rectangular transverse section.

The connection elements 12 are bare, having no insulating covering.

As illustrated in FIG. 6, each connection element 12 comprises a vertical rectilinear branch 13 extended at its bottom end by a lug 14 pressed under the power bar 5, on a large side thereof.

The lug 14 is for example welded to the power bar 5.

In a variant, the connection element 12 can be fixed mechanically to the power bar 5, for example by screwing or riveting or crimping.

The connection element 12 is connect at its top end 15 to another horizontal connection element 20 of the connection 4 in question, as can be seen in FIG. 4 in particular.

This junction is produced for example by electrical welding or, in a variant, mechanically, for example by screwing or riveting or crimping.

The top end 15 of the connection element 12 is distant from the cells 2, being accessible above these.

In the example in question, the horizontal connection elements 20, for example made from copper or aluminium, each comprise a central conductive portion 21 embedded in the mass of a common insulating support 22, as illustrated in FIG. 2.

The portions 21 of the connection elements 20 are insert moulded with a plastics material, for example polyamide, in order to form the insulating support 22 in the form of a plate with parallel flat faces.

Each portion 21 is extended, at one end, by a first vertical lug 25 connected to the branch 13 of the connection element 12 and, at the other end, by a second vertical lug 26 provided with a toe 27.

The lugs 25 and 26 at the end project over the edge of the plate 22.

The end 15 of the connection element 12 and the lug 25 extend through an opening 19 in the insulating support 22.

The lug 27 is introduced into an opening 28 in the printed circuit card 11, as illustrated in FIGS. 3 and 4.

This toe 27 is welded to the card 11, for example by a weld involving addition of material (for example of the tin/lead type) or wave welding.

The connection element 20 is thus electrically connected to a conduction track 29 of the printed circuit card 11.

Naturally, the shape of the first and second lugs 25 and 26 may be different.

In the example in question, the insulating support 22 carries eleven electrical connection elements for transmitting, to the electronic unit 3, information on the potential of ten energy storage cells 2.

It is found that, by virtue of the invention, the connections between the electronic unit 3 and the cells 2 can be simple and require a reduced number of operations, in particular compared with the use of electric wires.

In addition, the invention makes it possible to achieve positive location, unlike wires, which may be reversed, which avoids errors during assembly.

In the example that has just been described, the vertical connection element 12 is up against the lug 25 of the horizontal connection element 20 (see FIG. 4) in order to effect the junction.

Naturally, it is possible to connect the connection elements differently.

For example, as illustrated in FIG. 5, the connection element 12 connected to a power bar can extend horizontally and comprise an angled portion 30 inserted in an opening 31 produced on the connection element 20 carried by the insulating support 22.

As can be seen in FIG. 7, it is possible to provide a connection element 35 directly placed against a lateral wall 36 of one of the cells 2 with a view to transmitting information on potential.

This connection element 35 comprises a vertical lug 37 and, on each side of it, two lateral arms 38 placed against the top of the wall 36 of the cell 2.

This connection element 35 is for example formed by cropping and bending a metal sheet.

The lug 37 is provided with an orifice 39 for receiving a toe, not shown, of a connection element to be flanged to this lug 37.

FIG. 8 shows a connection element 40 comprising two substantially flat portions 41 and 42 separated by a bead 43. This bead 43 makes it possible to create a mechanical weakness able to absorb forces (for example vibrations), which limits the forces on the contacts with the cells 2.

This element 40 is placed on two adjoining cells 2, each portion 41 or 42 being in contact with a terminal of one of the cells 2.

The connection element 40 comprises a lug 44 with an orifice 39, like the lug 37 previously described.

The element 40 is produced for example by cropping and bending a metal sheet.

In this example, the element 40 serves both as a power conductor and for taking back information on potential via the toe 44.

Other forms of connection element can be provided.

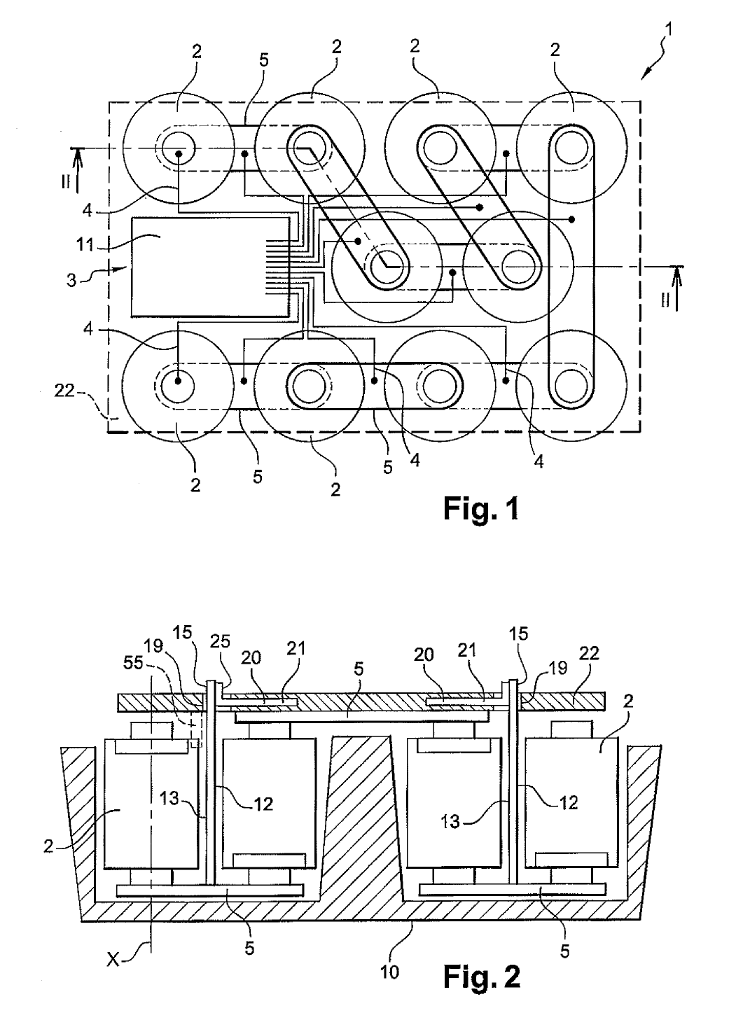

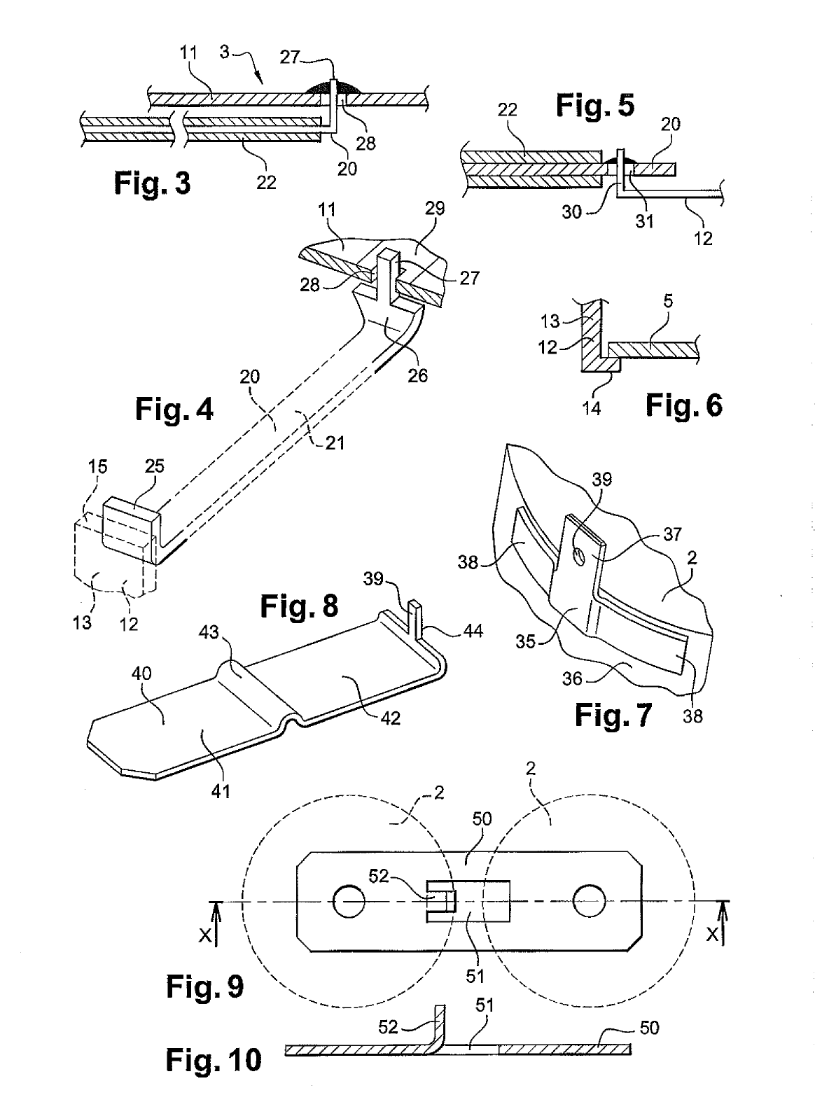

For example, FIGS. 9 and 10 show a connection element 50 also placed on top of the two cells 2, and serving as a power conductor.

This element 50, roughly rectangular in shape, comprises a central cutout 51 in which there extends a lug 52 intended to be connected to another connection element, not shown, for transmitting information on potential.

The element 50 is produced for example by cropping and bending a metal sheet.

Naturally the invention is not limited to the examples of implementation that have just been described.

For example, the insulating support 22 can be arranged to fit on top of the energy storage cells 2 and comprise, where applicable, one or more holding skirts 55 for holding the cells 2 with respect to one another, as illustrated in dotted lines in FIG. 2.

These skirts 55 are for example produced during the insert moulding of the connection elements 22.

The connection element 12 may, if so desired, be connected directly to the printed circuit card 11.

The invention can be applied to any electrical machine requiring a connection with an electrical source, for example a simple alternator.

1. Electrical energy storage device (1), for equipping a motor vehicle, comprising:
at least one energy storage cell (2),
an electronic unit (3), comprising in particular an electronic card (11), the electronic unit being different from a voltage converter, and
at least one electrical connection (4) connecting said at least one energy storage cell and the electronic unit to enable said electronic unit (3) to have available information representing an electrical quantity, in particular an electrical potential, of the energy storage cell, the electrical connection comprising at least one substantially rigid electrical connection element (12) provided with an end (15) remote from said at least one storage cell (2).

2. Device according to claim 1, the energy storage cell extending substantially along a longitudinal axis (X), wherein the substantially rigid electrical connection element (12) comprises at least one portion extending substantially parallel to the longitudinal axis of the cell.

3. Device according to claim 1, wherein the substantially rigid electrical connection element comprises at least one arm (13) extending vertically.

4. Device according to claim 1, wherein the substantially rigid electrical connection element (12) is connected to a power conductor (5), in particular a power connection bar itself connected to the energy storage cell.

5. Device according to claim 4, wherein the substantially rigid electrical connection element is welded to the power connection bar.

6. Device according to claim 4, wherein the substantially rigid electrical connection element (12) is mechanically assembled with the power connection bar.

7. Device according to claim 1, wherein the substantially rigid electrical connection element (35) is fixed, by welding or mechanical assembly, to a wall (36) of the energy storage cell, in particular a lateral wall thereof.

8. Device according to claim 1, wherein the substantially rigid electrical connection element (44) is formed directly on a power connection bar connected to the energy storage cell.

9. Device according to claim 8, wherein the substantially rigid electrical connection element issues from a cropping of material on the power connection bar.

10. Device according to claim 1, wherein one of the ends of the substantially rigid electrical element is fixed to the electronic unit.

11. Device according to claim 1, further comprising at least two adjoining energy storage cells, wherein the substantially rigid electrical connection element (12) extends between two adjoining energy storage cells.

12. Device according to claim 1, wherein the substantially rigid electrical connection element has a substantially rectangular transverse section.

13. Device according to claim 1, wherein the substantially rigid electrical connection element is bare.

14. Device according to claim 1, wherein the substantially rigid electrical connection element is at least partially produced from copper or aluminium.

15. Device according to claim 1, wherein the energy storage cell comprises at least one supercapacitor.

16. Device according to claim 1, wherein the electronic unit (3) comprises a circuit for balancing the energy storage cells.
